(19) United States
(12) Patent Application Publication
(10) Pub. No.: US 2002/0092999 A1
(43) Pub. Date: Jul. 18, 2002

(54) Flexible valve seat

(76) Inventors: Maria T. Longo, Industry, PA (US); Jennifer K. Peteritis, Painesville, OH (US); Victor N. Rasanow, Eastlake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/761,800

(22) Filed: Jan. 16, 2001

(51) Int. Cl. F16K 1/44

(52) U.S. Cl. 251/331; 251/333

(57) ABSTRACT

A plurality of embodiments of a flexible, discrete valve seat according to the present invention are provided for use in a high-purity valve. In one embodiment, the valve seat is retained in contact with a sealing surface on the valve body. In other embodiments, the valve seat can be retained by the actuating valve member, such as by a threaded connection, or via a welded connection. A high purity valve is provided having a flexible discrete valve seat that seals over an area of contact and is useful for many dynamic valve cycles. The valve seat according to the present invention can be metallic and of an intermediate hardness relative to the other sealing components, namely the valve member or diaphragm and the valve body.

### TECHNICAL FIELD OF THE INVENTION

The present invention relates to high purity valves for use in, for example, the semiconductor manufacturing industry. In such industries and others, the use of dynamic valves (on and flowing, and off and closed) for flow control of various fluids including heated, corrosive gases is common, and the need to control particulate contamination and achieve and maintain near absolute valve sealing is demanded. More particularly, the invention relates to valves using flexible, discrete valve seats and the seats themselves.

### BACKGROUND OF THE INVENTION

As is known in the art, valves with all-metallic sealing components may reduce sources of contamination in certain applications, versus valves with polymeric diaphragms, valve seats or gasket-like inserts. For example, in the electronic component and semiconductor manufacturing industries, highly pure conditioned gases are used in the production processes. In addition, these gases are often highly corrosive and heated. Polymeric sealing components suffer from some drawbacks in such applications.

Polymeric materials absorb moisture during their manufacture. This moisture can be released during valve operation into the high purity gas stream. Moisture can contaminate the lot of semiconductors or other electronic components being produced, thereby ruining them or severely restricting their useful life expectancies.

An additional source of contamination from polymeric diaphragms and valve seats is from particulate contamination released by the polymeric sealing components. These polymeric materials are susceptible to creep from repeated exposure to cyclic loads to close the valve. Creep of these materials is often accelerated with heat and the corrosive environments of the gases they are exposed to. As such, the polymeric sealing components may weaken, generate particulate contamination, and eventually rupture, thereby defeating the integrity of the highly effective seal required in the application. Additionally, a further source of potential contamination comes form the susceptibility of the polymeric sealing components to swelling. The contamination of these swollen polymeric sealing components comes form the possible later release of unwanted gases or moisture into the high purity environment.

A number of valves in the art have attempted to overcome the problems discussed above, by using all-metallic sealing components. Typically, a metallic diaphragm is urged against a metallic valve seat that is formed integral with the valve body. Further, the valve seats are typically manufactured from a softer metal than is the diaphragm, and are in the form of a radiused bead, or otherwise curved projection, surrounding the inlet passageway of the valve body. When the valve is actuated closed, the diaphragm sealingly contacts the seat in a circular line contact at the apex of the bead or projecting radiused seat. Even though manufacturing processes have advanced and highly smooth finishes can be achieved on these metallic sealing surfaces, surface deviations and inconsistencies from manufacturing still exist. This necessitates high loads to effectively seal the valve and prevent flow when required. These high loads impart stresses that exceed the material yield stress of the softest metallic mating surface, the valve seat. The radiused, or otherwise curved integral metallic valve seats become plastically deformed, flattening their desired line contact seal, and may cause particulate contamination.

This problem is most pronounced in high cycle valves, wherein leakage rates may only be on the order of 1×10 (to the minus fifth) to 1×10 (to the minus seventh) (atm.)(cc)/second.

It is desired, therefore, to provide an improved high purity valve that overcomes the problems of contamination, can be used in the relatively extreme environments of corrosive gases and temperatures exceeding 300° F., and provides a reproducible, highly effective seal for many dynamic valve cycles. It is a further, more specific object of the invention to provide a durable valve seat that produces a highly effective, reproducible surface seal whereby surface deviations and inconsistencies from manufacturing on valve sealing components can be compensated for by design.

### SUMMARY OF THE INVENTION

In accordance with the present invention, a valve is provided having a discrete, flexible valve seat that is characterized by the ability to withstand high cyclic loading and to elastically deform during valve actuation to close the valve, wherein the upper and lower surfaces of the valve seat substantially conform to a diaphragm or valve member and an integral, sealing surface on the valve body, respectively. In addition, the materials of the sealing components have a differential hardness such that the valve seat is of an intermediate hardness relative to the valve body and the valve member or diaphragm, as will be further explained below. In one embodiment, the valve member or diaphragm is metallic and of the highest hardness and the valve body is also metallic, but of the softest material.

The loads used to seal the valve of the present invention are such that maximum stress levels reached preferably should not exceed the material yield strength of any of the sealing components. Of course, it will be appreciated that due to manufacturing tolerances or actual use, localized imperfections or discontinuities may exist that result in material yield strength being exceeded in a very localized region. However, on an overall or macro-level, the valve seat of the present invention behaves elastically during valve actuation to close and open the flow passageway therein and is effective to perform in this elastic manner for a very high number of actuation cycles. A highly effective, reproducible surface seal is achieved with the upper and lower contacting surfaces of the valve seat that compensates for minor surface inconsistencies and surface finish variations of the sealing components. With such a flexible valve seat and the differential hardness of the sealing components, the valve of the present invention can tolerate high cycles while maintaining a near leak-free seal.

These and other aspects and advantages of the present invention will be apparent to those skilled in the art from the following description of the preferred embodiments in view of the accompanying drawings.

### BRIEF DESCRIPTION OF THE DRAWINGS

FIG. 1 is partial sectional view of an open valve showing an embodiment of a valve seat of the present invention.

FIG. 2 is an enlarged cross-sectional view of FIG. 1.

FIGS. 3a-3c are a series of three, enlarged partial cross-sectional views of a valve of the present invention illustrating what happens during valve actuation to close the valve.

FIG. 4 is partially assembled perspective view of a valve illustrating an alternative embodiment of a valve seat of the present invention.

FIG. 5 is an enlarged cross-sectional view of FIG. 4.

FIG. 6 is a cross-sectional view of an embodiment of an open valve of the present invention with the valve seat depicted in FIGS. 4 and 5 installed.

FIG. 7 is a cross-sectional view of an embodiment of a closed valve of the present invention with the valve seat depicted in FIGS. 4 and 5 installed.

FIG. 8 is a perspective view of a partially assembled valve of the present invention with the valve seat depicted in FIGS. 4 and 5 installed.

FIG. 9 is a partial cross-sectional view of an alternative embodiment of the valve seat of the present invention.

FIG. 10 is a partial cross-sectional view of another alternative embodiment of valve seat of the present invention.

### DETAILED DESCRIPTION OF THE PREFERRED EMBODIMENTS

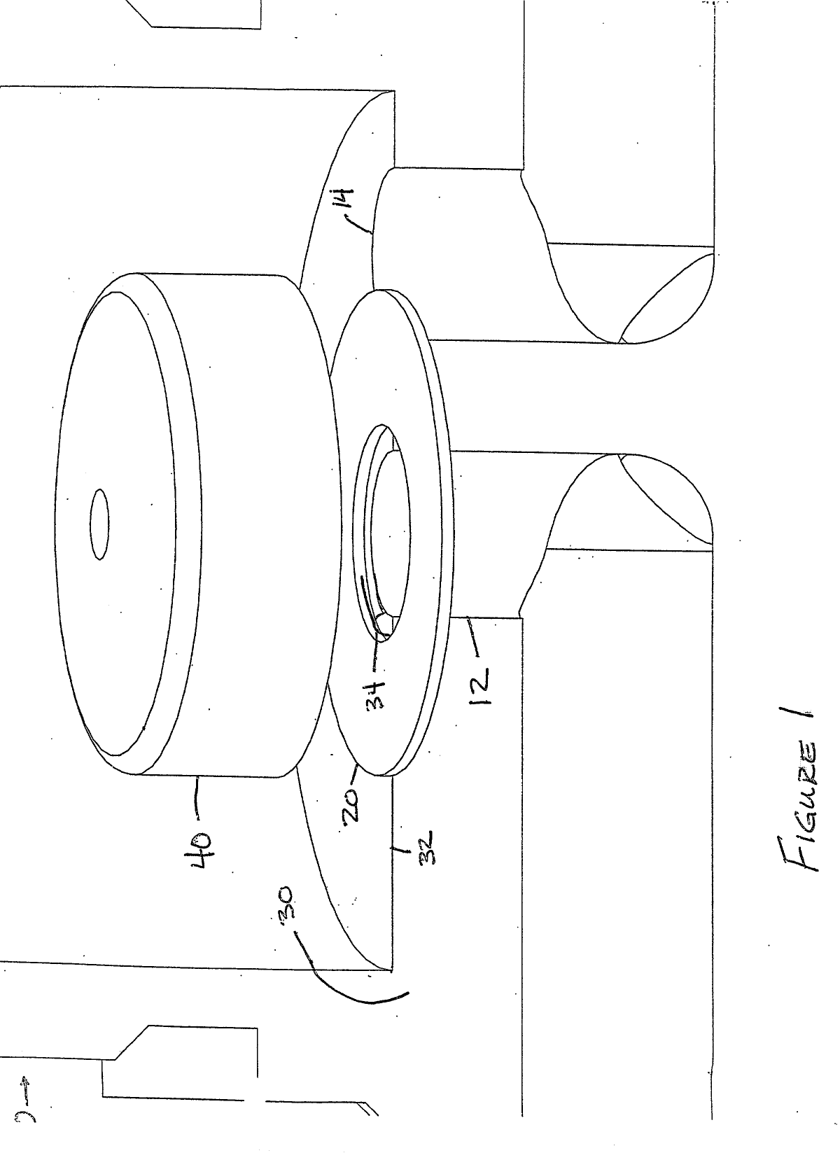

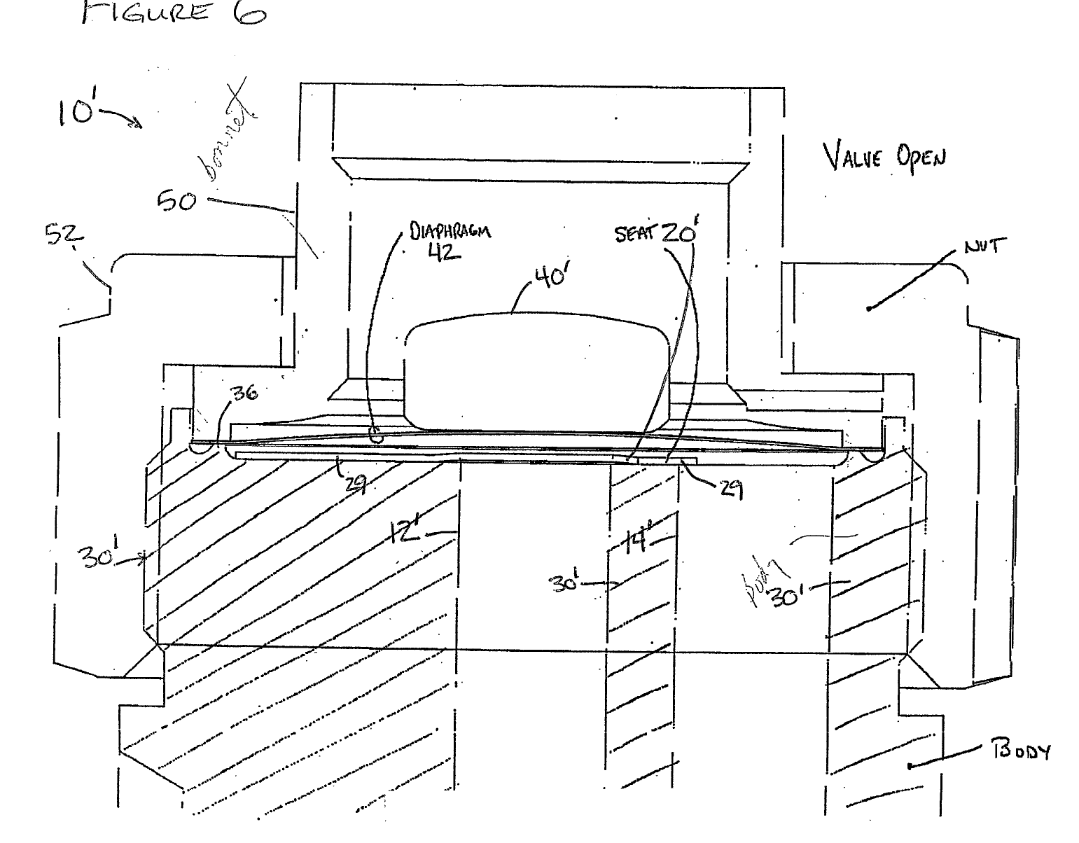

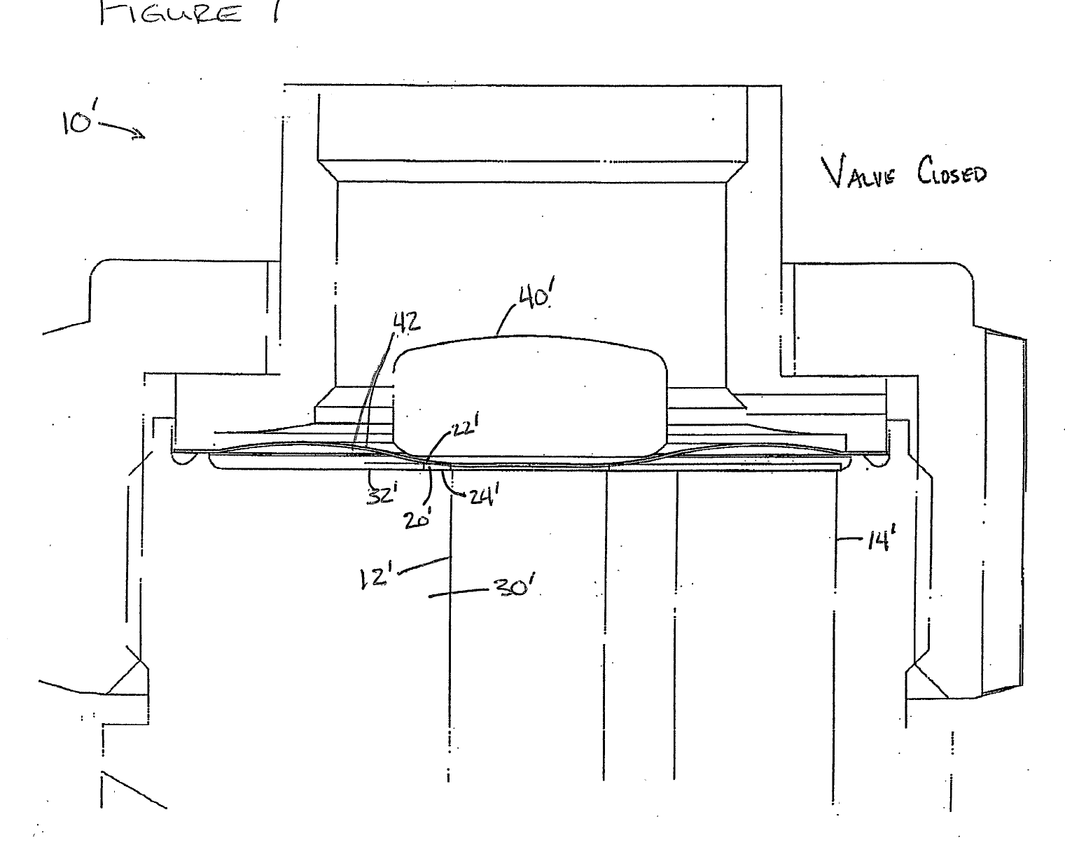

Referring now to the figures, which are for purposes of illustrating the present invention and not for limiting same, FIG. 1 depicts a valve 10 having a flexible, discrete valve seat 20 according to the present invention. In the FIG. 1 embodiment, valve seat 20 is illustrated as an annular-shaped seat encircling a fluid or gas flow passageway, typically the inlet, 12. An optional positioning means, such as a lip 34, may be used to keep valve seat 20 positioned around flow passageway 12. In the FIG. 1 illustrated embodiment, lip 34 may be integral with a valve body 30 and also surround the flow passageway 12. Also shown is another flow passageway, typically the outlet, 14, in fluid communication with flow passageway 12 when valve 10 is open and flowing. A valve member 40 can be urged directly against valve seat 20 to seal flow passageway 12 by compressing valve seat 20 against a sealing surface 32 that may be integral with a valve body 30, as will be explained further below. Alternatively, the valve member 40 can be urged against a diaphragm (see dual diaphragms 42 in FIGS. 6 and 7 for such an embodiment) to sealingly contact the valve seat 20 against the sealing surface 32 of the valve body 30, thereby preventing flow between passageways 12 and 14. In other anticipated embodiments that will be described more fully, infra, valve seat 20 may be retained by the valve member 40 instead of being retained adjacent the valve body 30 in surrounding relation to the fluid passageway 12.

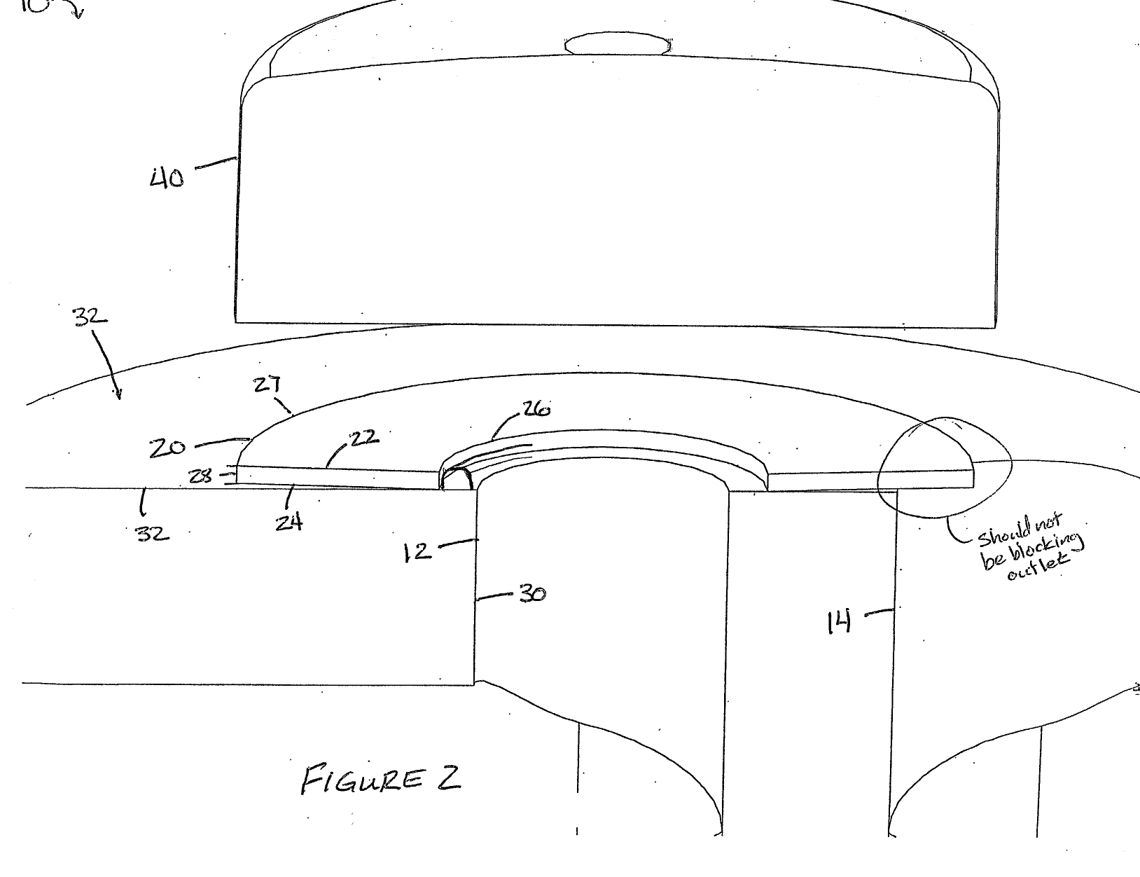

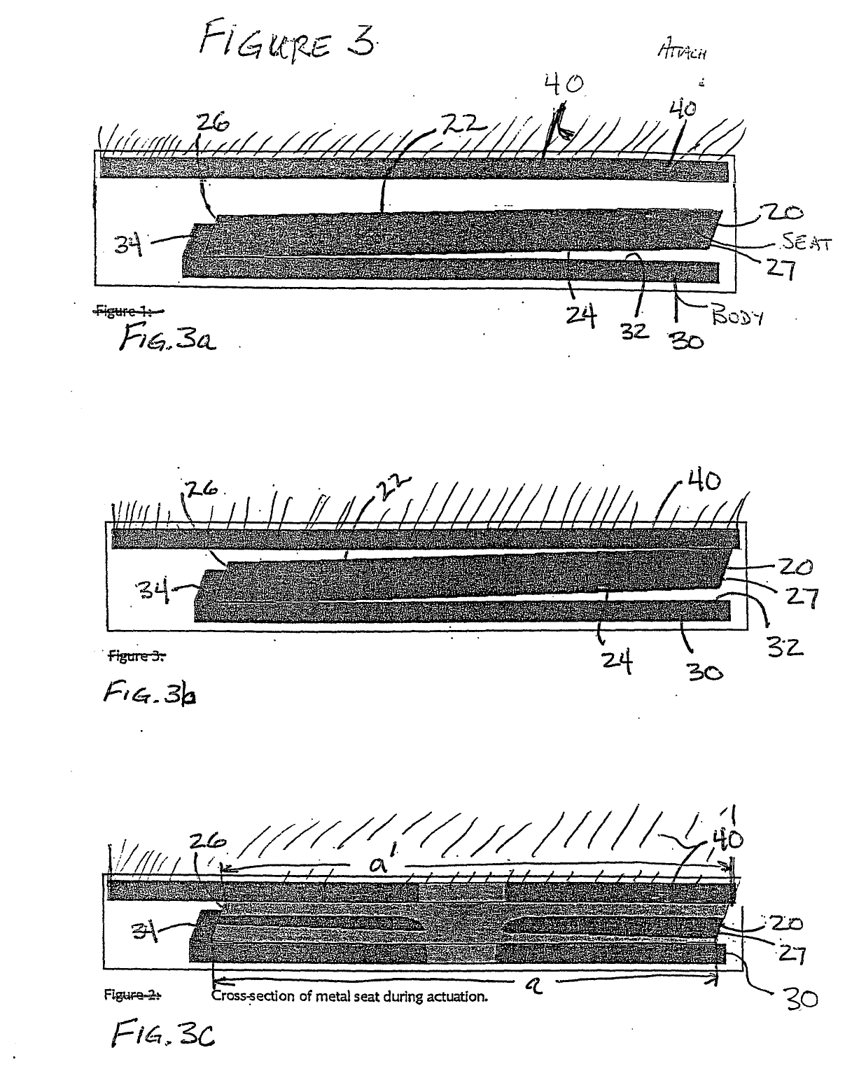

In FIGS. 2 and 3a-c, the novel features of valve seat 20 are more clearly shown. In the embodiment illustrated in FIG. 2, the valve 10 is nominally shown in the open position, with valve seat 20 in its elastically non-deformed state. As illustrated, valve seat 20 has an upper surface 22, a lower surface 24, an inner diameter 26, an outer diameter 27, and a thickness 28. In this embodiment, when valve 10 is open and flowing as shown in FIGS. 2 and 3a, the lower surface 24 of the valve seat 20 only contacts the sealing surface 32 of valve body 30 in a circular line contact; in this embodiment at the congruence of the inner diameter 26 and the lower surface 24.

FIGS. 3a through 3c illustrate what happens to the valve seat 20 during valve actuation to close the valve. In FIG. 3a, valve member 40 (or, optionally, diaphragm 42 being urged by valve member 40, as will be explained further below and shown in the embodiment depicted in FIGS. 6 and 7) is shown at rest, prior to actuation, with the valve in an open condition. The valve seat 20 is shown resting on its lower surface 24 at its inner diameter 26 on the valve body sealing surface 32.

In FIG. 3b, the valve is just beginning to close. The valve member 40 is shown just coming into contact the valve seat 20 on its upper surface 22 at its outer diameter 27.

As shown in FIG. 3c, when the valve is closed, the valve seat 20 is elastically deformed such that its lower surface 24 substantially conforms to the contour of the sealing surface 32 of valve body 30, which in this embodiment the sealing surface 32 is shown being substantially planar. Similarly, and simultaneously, the upper surface 22 of the flexible, elastically-deformed valve seat 20 conforms to the valve member 40 (or diaphragm, such as 42 in FIGS. 6 and 7) being urged against it to provide a near leak-free seal with valve seat 20 sandwiched between valve member 40 and the valve body 30. In this illustrated embodiment, the seal lengths a, a′ illustrated are the entire differences between the outer and inner radii of the upper and lower surfaces 22, 24 of the valve seat 20, respectively (i.e., since the entire upper and lower surfaces are in contacting relation and sealing, in this illustrated embodiment shown in FIG. 3c, the entire radial distance across the upper and lower surfaces are their respective seal lengths a, a′). Seal lengths are defined as the portion of the difference, at a specific circumferential location (for this annular embodiment illustrated), between the outer and inner radii on the upper and lower surfaces actually in contacting relation with the diaphragm or valve member and the sealing surface, respectively, when the valve is closed and the valve seat elastically deforms. Depending on mating geometries of the diaphragm or valve member, the valve seat and the sealing surface of the valve body desired for a specific application of this invention, seal lengths can vary on the upper and lower surfaces at the same circumferential location of the valve seat. Similarly, seal lengths can vary at different circumferential locations around the valve seat on the same surface.

As illustrated, the height of the optional positioning means, in this embodiment a lip 34, is less than the thickness 28 of valve seat 20 to ensure good sealing contact of substantial portions of both the upper and lower surfaces 22, 24 of valve seat 20 with valve member 40 and sealing surface 32, respectively. Finally, the valve can be re-opened to allow flow (as in FIG. 3a) with the valve member 40 no longer contacting the valve seat 20.

As shown in FIGS. 2 and 3a-c, but not meant as a limitation to the claimed invention, the illustrated annular valve seat 20 is non-planar, and non-conforming to the sealing surface 32 of the valve body 30 when the valve is open. In this embodiment of the invention, the valve seat 20 resembles a Belleville Spring-type washer. The flexible valve seat 20 elastically deforms and becomes substantially planar, sandwiched between the valve member 40 and the illustrated planar sealing surface 32, when the valve is closed (FIG. 3c), and then elastically springs back to its neutral, non-deformed, non-planar shape when the valve is reopened (as depicted in FIG. 3a). This surface sealing provides a near leak-free seal over an area of contact that compensates for surface incongruities at much reduced stress levels on the sealing components. Stresses in the sealing components, namely the valve seat 20, integral sealing surface 32 on the valve body 30 and the valve member 40 (or diaphragm), preferably should not reach yield stress during valve actuation.

In one embodiment, the valve member 40 (or diaphragm) is made from the hardest metal, such as a Nickel-based alloy like Elgiloy, the valve body 30 and its integral sealing surface 32 is constructed of the softest metal, such as a relatively low heat treat 316L steel, and the flexible discrete valve seat 20 is made from an intermediate hardness metal, such as a higher heat treat 316L steel than that of the valve body 30. Similarly, the valve member 40 or diaphragm has the highest material yield stress (e.g. 250 ksi), the valve body 30 has the lowest material yield stress (e.g. 80 ksi), and the valve seat 20 has a material yield stress between these upper and lower values (e.g. 120 ksi). Stresses on the valve body 30 when the valve 10 is actuated closed to prevent flow between the inlet 12 and outlet 14 are typically on the order of 75 to 85% of its material yield stress, and preferably never reach yield stress. Again, it will be appreciated that localized incongruities due to manufacturing or handling, for example, may cause a localized area to rise above yield stress, but on a macro-level, the valve seat 20 of the present invention preferably never reaches yield stress. Even with all stress levels below material yield stress for all the metallic sealing components, the flexible, discrete valve seat of the present invention provides for a highly effective seal. Leakage rates on the order of 1×10 (to the minus ninth) (atm.)(cc)/second can be achieved and maintained with the valve seat of the present invention. The mating surfaces herein described to provide the seal often have surface inconsistencies, or finish variations, from manufacturing or use that can be overcome by the surface sealing of the valve seat of the present invention. Depending on specific operational needs, flexibility in the valve seat of between about two and ten thousandths of an inch can be provided. Stated another way, the maximum deflection on any location of the valve seat between the non-deformed (valve open) and deformed (valve closed) states can be from about two to about ten thousandths of an inch or even, depending on specific needs for the valve and the flexible material chosen for the valve seat. Materials other than steel or other metals may perform satisfactorily as may be determined by one of skill in the art. Exemplary possible valve seat materials can include plastics, composites, and other metals, and are still contemplated within the scope of the present invention.

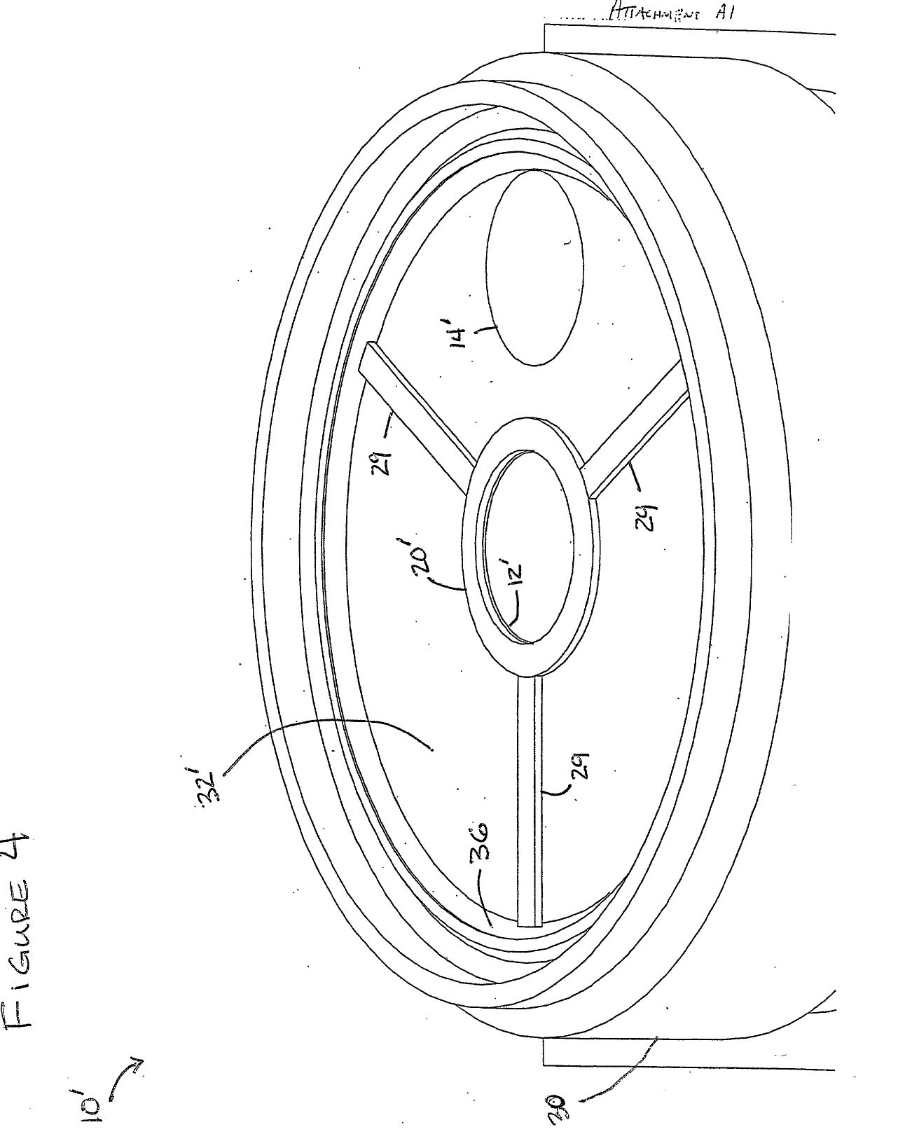

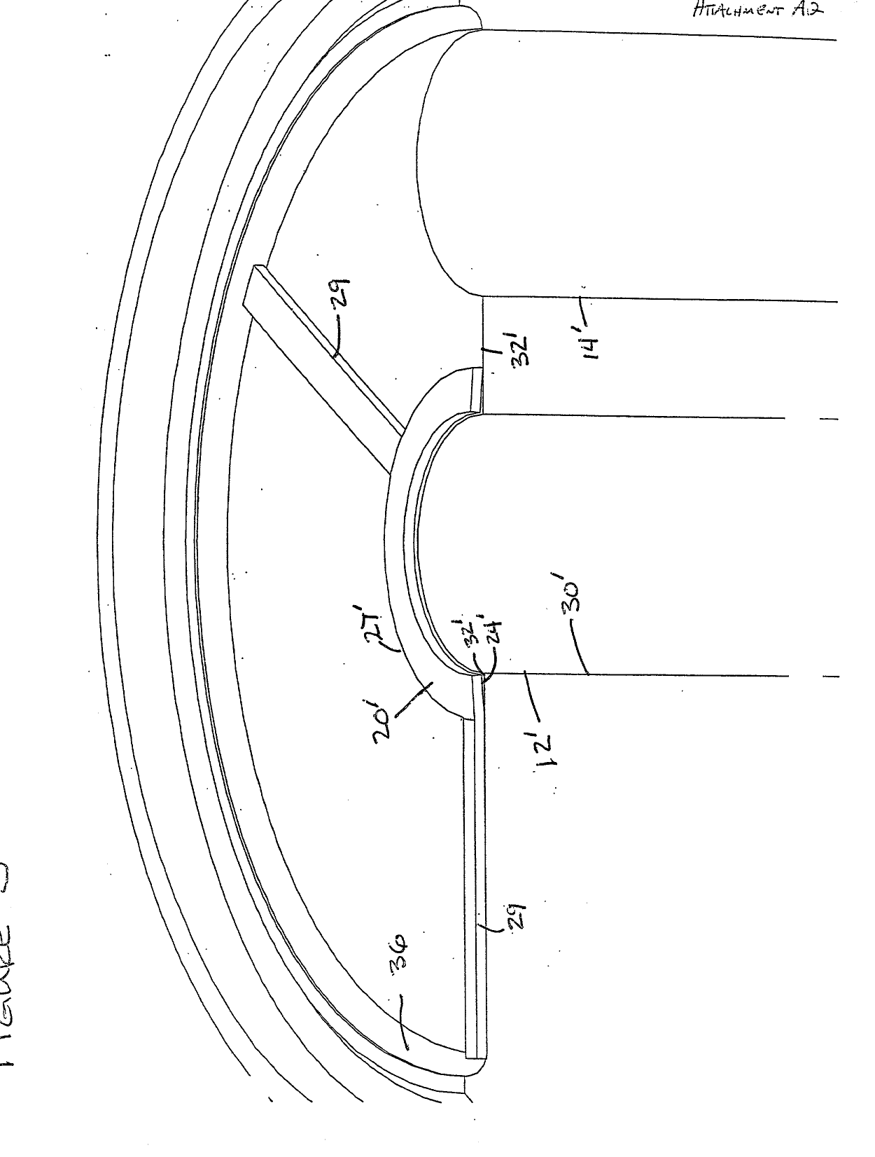

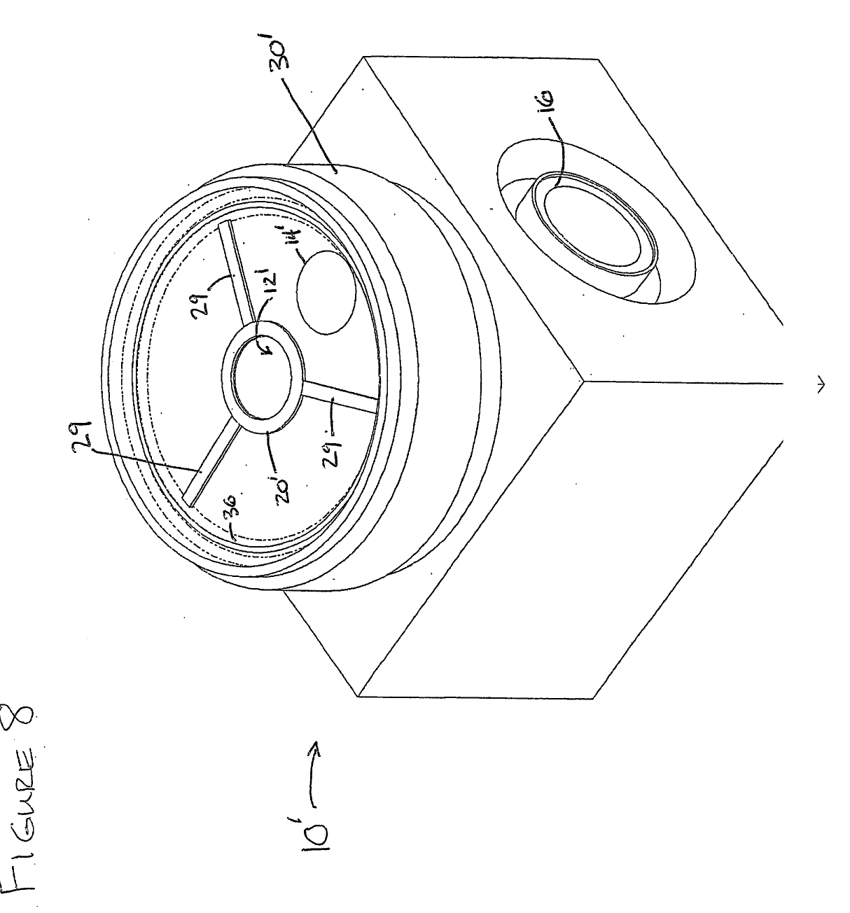

In FIG. 4, an alternative embodiment of the flexible, discrete metallic valve seat of the present invention is shown. FIG. 4 illustrates a valve 10′ with the bonnet and compression nut removed (and not shown), showing a valve seat 20′ resting on the sealing surface 32′ of valve body 30′ and surrounding a flow passageway 12′. Also shown is the corresponding flow passageway 14′ in fluid communication with flow passageway 12′ when the valve is open and flowing. An alternative positioning means is illustrated to locate the valve seat 20′ radially centered around, and substantially aligned with, the flow passageway 12′. A raised ridge 36, integral to the valve body 30′, is shown abutting three locator spokes 29, which may or may not be integral with the valve seat 20′ (see FIGS. 5 and 8 for a depiction of integral locator spokes 29′ with valve seat 20′). These locator spokes 29 may be of the same material thickness as the valve seat 20′, a slightly reduced thickness relative to the valve seat 20′, or of a tapered thickness at no point thicker than the valve seat 20′ to ensure effective sealing of valve seat 20′.

FIG. 5 shows an enlarged partial view, similar to that of FIG. 4, but with the locator spokes 29′ integral to the valve seat 20′. As illustrated in FIGS. 4 and 5, and different than the embodiment of the valve seat 20 of FIGS. 1-3a-c, valve seat 20′ is non-planar and non-conforming to sealing surface 32′ when the valve is open, but with only the lower surface 24′ contacting the sealing surface 32′ at its outer diameter 27′. The valve seat 20′ of FIGS. 4 and 5 is also an annular-shaped flexible, discrete metallic seat, and resembles a Belleville Spring-type washer. However, in this embodiment, the seat 20′ is reversed or upside down, relative to the embodiment depicted in FIGS. 1-3.

An alternative embodiment not illustrated, but envisioned by the inventors and within the scope of the invention herein, is an embodiment similar to that disclosed in FIG. 5, wherein the locator spokes are integral with a valve seat such as the valve seat 20 depicted in FIGS. 1-3. This would necessitate the locator spokes flexing with the valve seat to close the valve against the sealing surface, since the outer diameter of the valve seat would be raised, and integral with the locator spokes, relative to the sealing surface when the valve is open and flowing.

FIG. 6 depicts a valve 10′ in the open position, with the valve seat 20′ of FIGS. 4 and 5 installed. Shown are the valve body 30′, valve member 40′, valve bonnet 50, a threaded compression nut 52 to hold a double-layered diaphragm 42 between the valve bonnet 50 and the raised ridge 36 integral to the valve body 30′, and the flow passageways 12′ and 14′. Typically, flow passageway 12′ will be an inlet and 14′ will be the outlet.

FIG. 7 illustrates the valve 10′ of FIG. 6 in the closed position. During actuation, the valve member 40′ forces the double-layered diaphragm 42 against the flexible, discrete metallic valve seat 20′. The upper and lowers surfaces 22′, 24′ of valve seat 20′ conform to the diaphragm 42 being urged against it and the sealing surface 32′ of the valve body 30′, respectively.

FIG. 8 depicts a partially assembled perspective view of valve 10′ without either bonnet 50 or compression nut 52 installed. Spokes 29′ are clearly illustrated and shown as integral with the valve seat 20′ in this depiction (similar to FIG. 5). The geometry of valve body 30′ is clearly evident in this view. Also illustrated in FIG. 8 is a second end 16 of fluid passageway 14′ on the exterior of valve 10′ for coupling to other flow lines or devices.

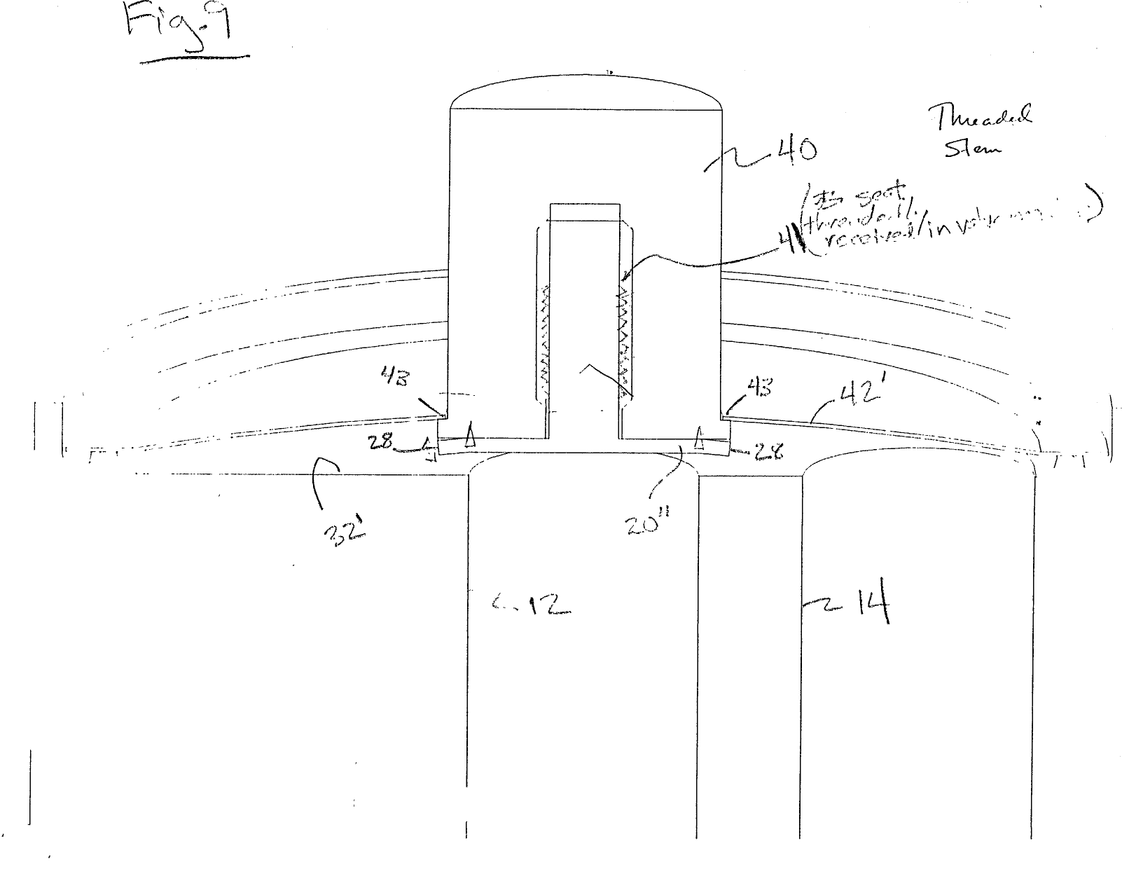

Of course it will be appreciated that additional embodiments are possible with an inventive valve having a discrete flexible valve seat according to the present invention. Specifically, the valve seat can be retained by the valve member 40 such that the valve seat is still aligned with and maintained in a surrounding relation to one of the fluid passageways, preferably the inlet. As shown in FIG. 9, valve seat 20″ is retained by valve member 40 via a threaded connection shown generally at 41. A diaphragm 42′ is shown connected to valve member 40, such as by a weld, at 43. In this embodiment, actuation of the valve member 40 brings the flexible discrete valve seat 20″ into sealing engagement with the sealing surface 32′ of the valve body 30. Similar to the embodiments described in more detail above, valve seat 20″ flexes to seal at its outer diameter or edge 28 over at least a portion of its radial length.

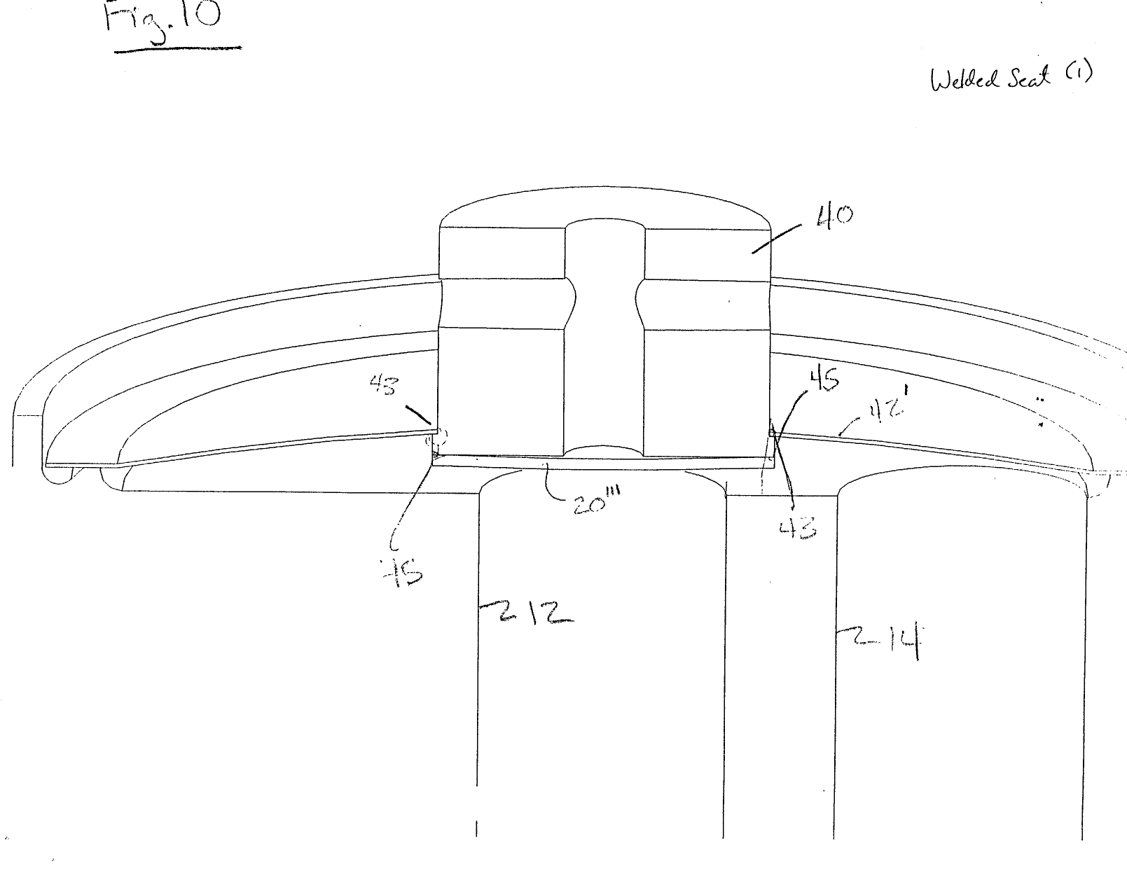

In yet another embodiment depicted in FIG. 10, valve seat 20′″ can be retained by valve member 40 via a welded connection shown generally at 45 proximate its outer edge 28. In this embodiment, a diaphragm 42′ is also shown connected to valve member 40, such as by a weld, at 43. I this embodiment, the flexure of valve seat 20′″ to seal and close passageway 12 would thus occur inboard of outer diameter or edge 28.

The embodiments illustrated herein are not meant to serve to limit the scope of the invention claimed. For example, existing valves with all metallic sealing surfaces can be modified to accept a discrete valve seat according to the present invention. One such valve that could be easily adapted to use the inventive valve seat is valve part number 6LV-DFHFR4-P-C, manufactured by Swagelok Company. Although described with reference to certain embodiments, certain modifications and variations of the general principles of the invention which may be apparent to those of skill in the art are all within the scope of the invention as defined by the accompanying claims and equivalents thereto.

I claim:

1. A flow-control valve comprising an inlet passageway, an outlet passageway and a discrete, flexible valve seat, said inlet passageway being in fluid communication with said outlet passageway when said valve is in an open condition, wherein said valve seat includes an upper surface, a lower surface, and an opening therethrough, wherein said opening is maintained aligned with and in surrounding relation with one of said passageways, and wherein said valve seat is elastically deformed when said valve is in a closed position, such that said upper and lower surfaces provide sealing surfaces over a portion of the areas of said seat surfaces.

2. The valve according to claim 1 wherein said seat is metallic and one piece.

3. The valve according to claim 1 wherein said seat is substantially planar when elastically deformed for sealing said valve when said valve is in said closed position, and non-planar when said valve is said open condition.

4. The valve according to claim 3 wherein said seat further comprises an inside diameter defining said opening that aligns with and surrounds one of said passageways and a substantially larger outside diameter.

5. The valve according to claim 4 wherein said inside diameter is raised relative to said outside diameter when said valve is open and said valve seat is non-planar.

6. The valve according to claim 4 wherein said outside diameter is raised relative to said inside diameter when said valve is in said open condition and said valve seat is non-planar.

7. The valve according to claim 5 or claim 6 wherein said outside or inside diameter is raised relative to said inside or outside diameter, respectively, by between about two and ten thousandths of an inch when the valve is in said open condition.

8. The valve according to claim 1 wherein said opening of said valve seat surrounds said inlet passageway.

9. The valve according to claim 1 wherein said upper and lower surfaces seal over substantially their entire areas when said valve is in said closed condition.

10. The valve according to claim 1 further comprising means for positioning said valve seat for surrounding said flow passageway within said valve.

11. The valve according to claim 1 wherein the seat is retained in contacting relation with a sealing surface of the valve body.

12. The valve according to claim 1 wherein the seat is retained by a valve member.

13. A valve for controlling gas or fluid flow, comprising:
an inlet having a proximal end internal to said valve and a distal end external to said valve;
an outlet;
a metallic valve body in fluid communication with said inlet and said outlet, said valve body having an integral, internal sealing surface surrounding said proximal end;
a bonnet;
a threaded compression nut for securing said bonnet with said valve body;
a flexible, discrete valve seat having a hole therethrough for aligning with and surrounding said proximal end, said seat further having a substantially constant thickness, an upper surface and a lower surface and a closed condition wherein said seat is elastically deformed to conform a portion of the area of said lower surface to said integral sealing surface of said valve body; and
a valve member for urging against said upper surface of said seat to elastically deform said seat when said valve is closed such that a portion of the area of said upper surface contacts and conforms to said valve member.

14. The valve according to claim 13 further comprising a flexible metallic diaphragm, wherein said diaphragm is held in position by said compression nut sandwiching said diaphragm near an outer edge of said diaphragm between said bonnet and said valve body; said valve member urges said diaphragm against said upper surface of said flexible valve seat to close said valve by substantially conforming said lower surface to said sealing surface and said upper surface to said diaphragm being urged against said upper surface.

15. The valve according to claim 14 wherein said diaphragm is also connected to said valve member.

16. The valve according to claim 13 further comprising means for positioning said valve seat being aligned with and surrounding said proximal end.

17. The valve according to claim 16 wherein said means for positioning comprises an integral raised ridge of said sealing surface near an outer edge of said sealing surface, and two or more spokes for holding said seat aligned with and surrounding said proximal end, said spokes having a first end terminating substantially at said seat and a second end terminating substantially at said raised ridge, said spokes being no thicker than said thickness of said seat.

18. The valve according to claim 16 wherein said proximal end defines a lip extending internally into said valve body a distance less than the thickness of said seat, said lip defining said means for positioning, and said opening aligning with and surrounding said lip.

19. The valve according to claim 13 wherein said sealing surface is made from a softer metal than said seat, and said seat is made from a softer metal than said valve member.

20. The valve according to claim 19 wherein said load on said sealing surface never exceeds the material yield stress during closure of said valve.

21. The valve according to claim 19 wherein said valve seat is made of Elgiloy, the valve body is made of a relatively low heat treat 316L steel and the diaphragm is made of a relatively high heat treat 316L steel.

22. The valve according to claim 13 wherein said proximal end defines a substantially circular opening, said valve seat is substantially in the form of a non-planar annular plate when said valve is open, and said valve seat is substantially in the form of a planar annular plate when said valve is closed, said annular plate having an inner diameter defining said hole.
